(19) United States
(12) Patent Application Publication
(10) Pub. No.: US 2012/0331507 A1
(43) Pub. Date: Dec. 27, 2012

(54) SYSTEMS AND METHODS FOR PROVIDING LOCAL EVENT LISTINGS WITH VIDEO

(75) Inventor: Walter R. Klappert, Los Angeles, CA (US)

(73) Assignee: UNITED VIDEO PROPERTIES, INC., Santa Clara, CA (US)

(21) Appl. No.: 13/167,516

(22) Filed: Jun. 23, 2011

(51) Int. Cl. H04N 5/445

(52) U.S. Cl. 725/47; 725/53

(57) ABSTRACT

Systems and methods are provided for generating an integrated event listing. An event promoter may input event information about a local event. In response, online videos corresponding to the event information may be identified and provided to the event promoter. The event promoter may select one or more of the identified online videos to integrate with the event information to generate the integrated event listing. For example, the integrated event listing may be generated by displaying the one or more selected online videos as a video background behind a scrolling text overlay of the event information.

### BACKGROUND

The present disclosure is generally directed to providing local event listings with video and, more particularly, to providing local event listings in the context of event promoters, editors, and viewers.

A local event listing is a listing that provides information about a local event, such as a baseball game, a live music concert, or an outdoor art festival. Typically, an event promoter may promote an event in a newspaper, online, or, more rarely due to some of the limitations described herein, on television.

With the growing lack of local newspapers, the traditional source for local event listings and other listings, a need has emerged to provide local event listings via television and the Internet. Unlike the Internet, however, television is oriented primarily toward video display. With the ever-increasing abundance of videos currently available on the Internet, event promoters may not be fully aware of all of the video resources ready for download which could assist in promoting their local event listings. Furthermore, event promoters may prefer not to promote local event listings on television due to the difficulty in working with television service providers, the costs incurred by the television advertisement process, or both.

### SUMMARY OF THE DISCLOSURE

Systems and methods are provided for generating an integrated event listing. In particular, systems and methods are provided for adding video content to local event listings to facilitate the creation of television-ready local event listings with accompanying video. For example, the integrated event listing may include an online video displayed behind a scrolling text overlay of the event information associated with the local event listing.

The systems and methods of the present disclosure enable an event promoter (e.g., a person or entity promoting an event) to generate an integrated event listing using an event listings application. In an embodiment, the event listings application receives event information from the event promoter or any other suitable source. The event listings application generates a search expression based on the received event information and searches to identify media content based on the search expression, such as videos, images, or audio files. The event listings application provides the identified media content to the event promoter as a plurality of selectable listings. The event listings application may then receive a selection of one of the listings from the event promoter and generate the integrated event listing by integrating (e.g., using data integration or data fusion processes) the received event information and the selected media content.

### BRIEF DESCRIPTION OF THE DRAWINGS

Features of the disclosure, its nature, and various advantages will be apparent upon consideration of the following detailed description, taken in conjunction with the accompanying drawings, in which like reference characters refer to like parts throughout, and in which:

FIG. 1 is a block diagram of an illustrative integrated event listings management system in accordance with some embodiments;

FIG. 2 is a block diagram of an illustrative equipment device in accordance with some embodiments;

FIG. 3 shows an illustrative event listings application display screen for inputting event information in accordance with some embodiments;

FIG. 4 shows an illustrative event listings application display screen for selecting media content in accordance with some embodiments;

FIG. 5 shows an illustrative event listings application display screen for managing integrated event listings in accordance with some embodiments;

FIG. 6 shows an illustrative integrated event listings application display screen for displaying integrated event listings in accordance with some embodiments;

FIG. 7 is a flow chart of illustrative steps involved in generating integrated event listings in accordance with some embodiments; and

FIG. 8 is a flow chart of illustrative steps involved in customizing integrated event listings in accordance with some embodiments.

FIG. 9 is a flow chart of illustrative steps involved in managing integrated event listings in accordance with some embodiments.

### DETAILED DESCRIPTION OF EMBODIMENTS

The integrated event listings and applications of the present disclosure are described in the context of an event listings application and an integrated event listings application.

An integrated event listing includes event information integrated with any suitable media content. Event information may be electronic text indicative of an occurrence, social gathering, or any other suitable activity occurring at a specified location during a specified interval of time. For example, event information may be electronic text indicative of a Burbank High School vs. Pasadena High School Baseball Game occurring at Burbank High School, 902 N Third St, Burbank, Calif. 91502 on Apr. 2, 2010 at 7:00 pm Pacific Daylight Time (PDT). Media content may be a video, an image, audio, or any suitable combination and may be stored online or in a local storage device, such as a personal computer (PC) or digital video recorder (DVR). For example, media content may be an online video of a previous Burbank High School vs. Pasadena High School baseball game.

In an embodiment, the event listings application may integrate event information input by an event promoter with media content identified by the event listings application and selected by the event promoter using any suitable data integration or data fusion process. Data integration is directed towards combining or unifying data residing in different data sources. In an embodiment, the event listings application may use a data integration process to combine the event information and the selected media content. Data fusion is directed towards combining data from multiple data sources and gathering the combined information in order to produce fused data. In an embodiment, the event listings application may use a data fusion process to combine the event information and the selected media content, reduce or otherwise process the combined data, and replace the combined data with the processed data. For example, the event listings application may combine a data file that includes the event information with a data file that includes the selected media content to generate a new data file (e.g., an integrated event listing data file) that includes the information from the combined data files.

In an embodiment, the integrated event listing includes event information displayed in a foreground overlay over a video background. For example, the integrated event listing may include an online video with a scrolling text overlay indicative of an event listing for a local event, such as a concert, an opening of a new business, a career fair, a sports competition or any suitable activity or occurrence.

It will be appreciated that while the discussion of integrated event listings may be focused on textual event information combined with video content, the principles of integrated event listings may be applied to any suitable type of media content, such as graphical images, audio content, any other suitable content, or any suitable combination. Graphical images may include, for example, cover art, still images, video clip previews, live video, other types of media, or any suitable combination. Audio content may include, for example, music, spoken word, sound effects, any other suitable audio content, or any suitable combination.

The event listings application provides an event promoter, an event editor, or both with a platform to generate and manage the integrated event listing. The event promoter is a person or entity that promotes a local event with the purpose of getting people to attend the event. For example, the event promoter may be a person who creates hype about a local event. The event editor is a person or entity that manages the integrated events listing generated by the event promoter for delivery to a user. For example, the event editor may be a person working on behalf of a television service provider. The user is a person or entity that views the integrated event listing. For example, the user may be a television viewer, a computer user, a mobile device user, or any other suitable user or entity.

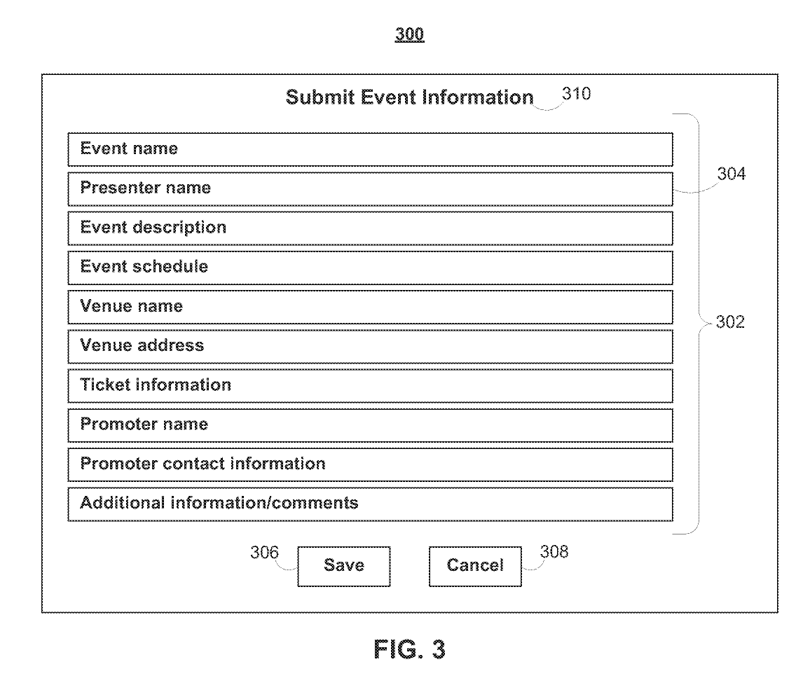

The event listings application allows the event promoter to generate the integrated event listing by associating media content with event information via selectable media content listings. In an embodiment, the event listings application allows the event promoter to input event information related to a local event using a web browser running on a personal computer. The event listings application automatically generates search expressions from the event information and searches for online videos. The event listings application then provides identified videos to the event promoter as selectable listings displayed in the web browser. The event promoter may then select one of the listings to use as a video background for the event promoter's integrated event listing. The event listings application receives the event promoter's selection and generates the integrated event listing as a foreground overlay of the event information input by the event promoter and the video selected by the event promoter. For example, the event listings application may enable the event promoter to generate the integrated event listing via the illustrative display screens shown in FIGS. 3-5, any other suitable display screen, or any suitable combination, which may be implemented on any suitable device or platform.

In an embodiment, the event listings application may automatically search for event information. For example, the event listings application may search for events listed in online newspapers or websites using an online content guide. Systems and methods for providing a guide to online events are discussed in greater detail in connection with Fereira et al., U.S. patent application Ser. No. 12/603,139, filed Oct. 21, 2009, which is hereby incorporated by reference herein in its entirety.

The event listings application allows the event editor to manage the integrated event listing and provide the integrated event listing to the integrated event listings application for distribution to users. Integrated event listings management includes generating, reviewing, editing, conforming, organizing, packaging, or compiling integrated event listings, performing any other suitable function, or any suitable combination. For example, integrated event listings management may include preparing multiple integrated event listings for distribution by a television distribution facility. The event listings application may enable the event editor to manage the integrated event listing via the illustrative display screens shown in FIGS. 3-5, any other suitable display screen, or any suitable combination, which may be implemented on any suitable device or platform.

The integrated event listings application provides the integrated event listing to the user through an interface that allows the user to navigate and identify events of interest to the user. The integrated event listings application may take various forms depending on the integrated event listing for which guidance is provided. For example, the integrated event listings application may be accessed through or added to an interactive television program guide.

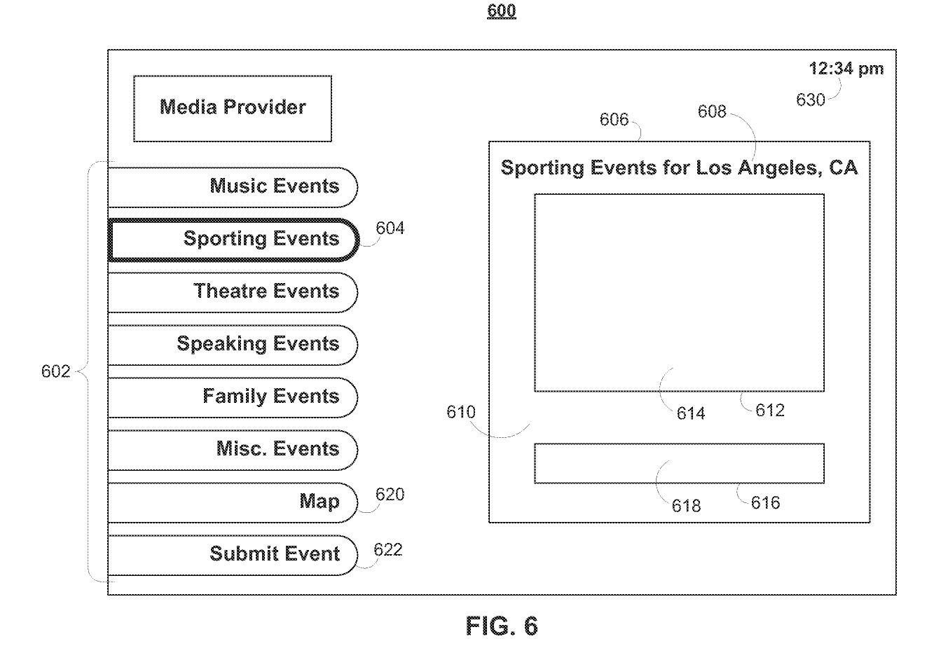

In an embodiment, the integrated event listings application allows the user to access or indicate a desire to access integrated event listings by selecting a displayed option (e.g., a menu option, a listings option, an icon, a hyperlink, any other suitable option, or any suitable combination) provided in a display screen, pressing a dedicated button (e.g., a GUIDE button, a soft key, any other suitable button, or any suitable combination) on a user equipment device, making a selection using a touchscreen or other user input interface or device, issuing a voice command, performing any other suitable action, or any suitable combination. For example, the integrated event listings application may enable the users to access the integrated event listing via the illustrative display screen shown in FIG. 6, any other suitable display screen, or any suitable combination, which may be implemented on any suitable device or platform.

The integrated event listings application organizes and provides the integrated event listing to the user in any suitable manner. For example, the integrated event listings application may provide the integrated event listing along with other integrated event listings in a grid format, a list, any other suitable format or grouping, or any suitable combination. In certain embodiments, the integrated event listings application may provide integrated event listings that include links to media content organized in a grid, by popularity, by location, by time, by channel, by media type, by category (e.g., music, sports, theatre, speaking, family, web content any other category, or any suitable combination), by promotional criteria, by any other suitable predefined or user-defined organization criteria, or any suitable combination.

The integrated event listings application may provide the integrated event listing to the user via any suitable equipment device, communications path, or both. For example, the integrated event listings application may provide the integrated event listing to an equipment device via a dedicated display region, a dedicated broadcast, a Video-On-Demand (VOD) option, an audio-on-demand option, one or more dedicated channels, any other suitable application or platform, or any suitable combination.

In an embodiment, the integrated event listings application may be personalized based on the user's preferences. For example, the personalized integrated event listings application may allow the user to customize displays and features to create a personalized “experience” with the integrated event listings application. This personalized experience may be created by allowing the user to input these customizations, by the integrated event listings application monitoring the user's activity to determine various user preferences, or both. The user may access the personalized integrated event listings application by logging in or otherwise providing identification to the integrated event listings application.

In an embodiment, the integrated event listings application may allow the user to customize the integrated event listings application. For example, customization of the integrated event listings application may be made in accordance with a user profile. The customizations include the varying of presentation schemes, aspects of integrated event listings displayed, parental control settings, any other desired customizations, or any suitable combination. Presentation schemes include the color scheme of displays, the font size of text, any other suitable scheme, or any suitable combination. Aspects of integrated event listings displayed include displaying only specified integrated event listings (e.g., only integrated event listings for sporting events), user-specified event types based on favorite event type selections, re-ordering the display of event types, recommended event content, any other suitable aspect, or any suitable combination.

In an embodiment, the integrated event listings application allows the user to provide user profile information. In another embodiment, the integrated event listings application may automatically compile user profile information from the user. For example, the integrated event listings application may monitor the media the user accesses, the geographic location where the user accesses the media, or other interactions the user has with the integrated event listings application.

In an embodiment, the integrated event listings application may obtain all or a portion of other user profiles that are related to the user. For example, the integrated event listings application may obtain profiles from other users near the geographic location of the user, from other web sites on the Internet (e.g., http://www.tvguide.com), from other integrated event listings applications, from other interactive applications, from other equipment devices, from any other suitable information or component, or any suitable combination. As a result, the user may be provided with a unified integrated event listings application experience across the user's equipment devices. For example, the user may direct the integrated event listings application on the user's television to only provide integrated event listings for sporting events located near Los Angeles, Calif. In response, the integrated event listings application may only provide integrated event listings for sporting events located near Los Angeles, Calif. on the user's other devices, such as the user's tablet computer and the user's personal computer.

In an embodiment, the integrated event listings application may be a stand-alone interactive television application that receives the integrated event listing via a data feed. For example, the integrated event listings application may provide the integrated event listing to the user equipment on one or more analog or digital television channels, on a television channel sideband, in the vertical blanking interval of a television channel, using an in-band digital signal, using an out-of-band digital signal, in a continuous feed, in a trickle feed, or by any other suitable data transmission technique.

In an embodiment, the integrated event listings application may provide the integrated event listings to the equipment device with any suitable frequency, such as continuously, daily, a user-specified period of time, a system-specified period of time, in response to a request from user equipment, any other suitable frequency, or any suitable combination. For example, the integrated event listings application may provide integrated event listings for sporting events at a real-time or near real-time rate and provide integrated event listings for family events at a daily rate in accordance with the user's preferences, actions (e.g., behavior), or both.

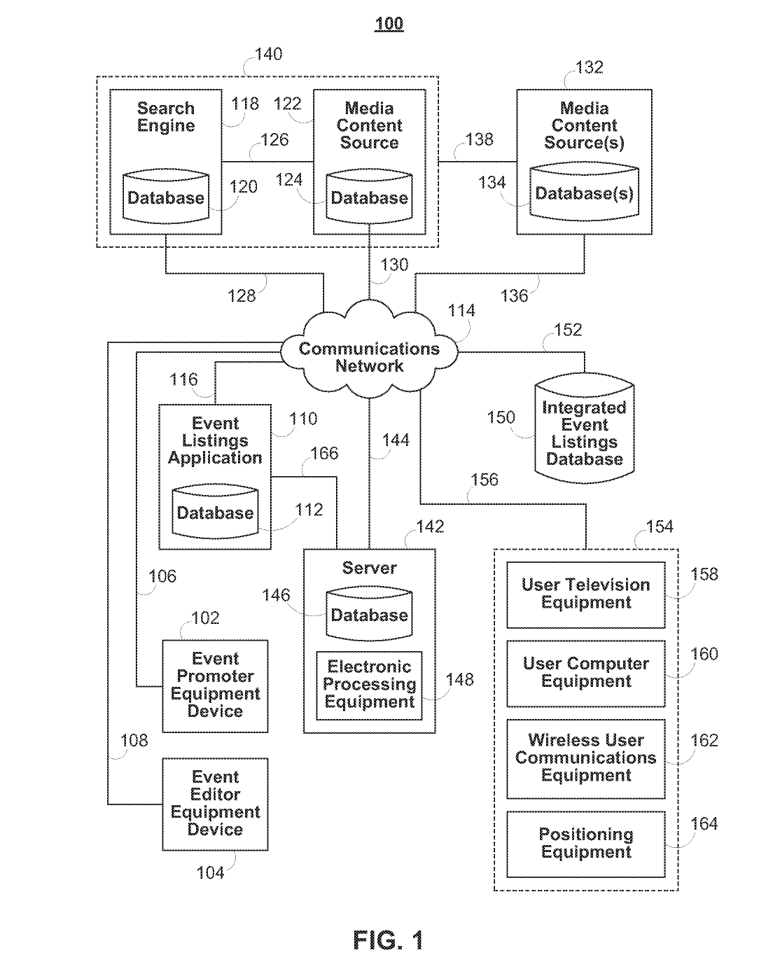

Illustrative features of the present disclosure are described with reference to FIGS. 1-8 below.

FIG. 1 is a block diagram of an illustrative integrated event listings management system 100. System 100 is one example of a suitable architecture used in connection with implementing the event listings application and the integrated event listings application having integrated event listings management capabilities. Other architectures may be used and may include more or fewer components than those illustrated.

To provide for interaction with the event promoter, system 100 includes event promoter equipment device 102. Event promoter equipment device 102 may include hardware, software, or both for receiving and displaying information. For example, event promoter equipment device 102 may include any suitable input device or interface, such as a computer keyboard and mouse. Event promoter equipment device 102 may also include any suitable output device or interface, such as a computer monitor.

To provide for interaction with the event editor, system 100 includes event editor equipment device 104. Event editor equipment device 104 may include hardware, software, or both for receiving and displaying information. For example, event editor equipment device 104 may include any suitable input device or interface, such as a computer keyboard and mouse. Event editor equipment device 104 may also include any suitable output device or interface, such as a computer monitor.

System 100 includes event listings application 110, which may include hardware, software, or both. In an embodiment, event listings application 110 may be one or more stand-alone applications used in connection with event promoter equipment device 102, event editor equipment device 104, or both. For example, event listings application 110 may be provided as a web site accessed by a web browser. In another embodiment, event listings application 110 may be one or more client-server applications where the client resides on event promoter equipment device 102, event editor equipment device 104, or both.

Event listings application 110 provides fields for receiving event information from the event promoter, event editor, or both. Fields for receiving event information may include selectable fields for inputting an event name, presenter name, event description, event schedule, venue name, venue address, ticket information, promoter name, promoter contact information, confirmation options, any other suitable field, or any suitable combination using event promoter equipment device 102, event editor equipment device 104, or both. In an embodiment, event listings application 110 provides a pre-populated field for receiving an event category selection. For example, event listings application 110 may receive a selection of a sporting events category from amongst pre-populated selectable event categories for music events, sporting events, theatre events, speaking events, and family events.

In an embodiment, event listings application 110 may include electronic database 112. Electronic database 112 may include any suitable software for storing and manipulating data. Electronic database 112 may store and retrieve data from one or more types of storage devices, such as memory (e.g., random-access memory, read-only memory, synchronous dynamic random access memory, EPROM, EEPROM, flash memory devices, any other suitable memory, or any suitable combination), hard disks, magneto-optical disks, optical disks, any other suitable fixed or removable storage devices, or any suitable combination.

Event listings application 110 may store information received from event promoter equipment device 102, event editor equipment device 104, or both in electronic database 112, any other suitable database, or any suitable combination. For example, event listings application 110 may store event listings information in database 112 in response to the event promoter selecting a confirmation option (e.g., “Save”).

In an embodiment, event listings application 110 may store event listings information, preference information, profile information, any other suitable information, or any suitable combination in database 112 for use in managing integrated event listings. For example, event listings application 110 may store addresses and contact information associated with specific event venues in database 112 for ease of generating integrated event listings.

Event listings application 110 may generate the integrated event listing via event promoter equipment device 102. For example, event listings application 110 may integrate text (e.g., in a foreground overlay) and video (e.g., in a background video display region) to generate the integrated event listing in response to the event promoter using event promoter equipment device 102 to input textual event information and select one or more online videos to accompany the inputted event information. In an embodiment, event listings application 110 may associate the event information and the selected media content with each other and display the non-integrated event information and selected media content on user equipment 154.

Event listings application 110 may edit, compile, or otherwise manage an integrated event listing via event editor equipment device 104. For example, event listings application 110 may customize the text and duration of integrated event listings and compile a series of edited integrated event listings to generate distribution-ready integrated event listings in response to actions performed by the event editor using event editor equipment device 104.

Event promoter equipment device 102 and event editor equipment device 104 are coupled to event listings application 110 via communications paths 106 and 108, respectively. Communications paths 106, 108, or both may include one or more communications paths, such as a satellite path, a fiber-optic path, a cable path, a path that supports Internet communications, a path that supports Internet communications, a path that supports free-space connections (e.g., for broadcast or other wireless signals, Bluetooth, infrared, IEEE 802-11x, any other suitable path, or any suitable combination), one or more busses, USB cables, IEEE 1394 cables, Super Video Graphics Array (SVGA) cables, any other suitable wired or wireless communications path, or any combination of such paths. Communications paths 106, 108, or both may be provided by one or more of these communications paths, but are shown as single paths in FIG. 1 to avoid overcomplicating the drawing. In an embodiment, event promoter equipment device 102, event editor equipment device 104, or both may be coupled to event listings application 110 through an indirect path via communications network 114. In another embodiment, event promoter equipment device 102 and event editor equipment device 104 may be coupled to each other through an indirect path via event listings application 110, communications network 114, or both.

Event listings application 110 may be coupled to any suitable circuitry for communicating with communications network 114, server 142, any other suitable network or server, or any suitable combination. This circuitry may include, for example, a cable modem, an integrated services digital network (ISDN) modem, a digital subscriber line (DSL) modem, a telephone modem, a wireless modem, any other suitable communications device, or any suitable combination.

Event listings application 110 is coupled to communications network 114 through communications path 116. Communications network 114 may include one or more networks, such as the Internet, a mobile phone network, a mobile device (e.g., BlackBerry) network, a cable network, a cable television system, a public switched telephone network, a Wi-Fi network, a WiMax network, a satellite network, a local area network (LAN), a wireless local area network (WLAN), or other types of communications network or combinations of communications networks.

Event listings application 110 is coupled to server 142 through communications path 166. In an embodiment, event listings application 110 may be coupled to server 142 through an indirect path via communications network 114.

Communications paths 116 and 166 may include any suitable communications paths, such as those described with reference to communications paths 106 and 108. Communications paths 116, 166, or both may be provided by one or more of these communications paths but are shown as single paths in FIG. 1 to avoid overcomplicating the drawing.

System 100 includes distributed computing network 140, which may include one or more of the following components: search engine 118; electronic database 120; media content source 122; electronic database 124; any other suitable component; or any suitable combination. In an embodiment, distributed computing network 140 may include one or more private networks, public networks, or both. For example, distributed computing network 140 may include one or more publically-accessible web sites operating on the Internet.

Search engine 118 may include any suitable hardware, software, or both. In an embodiment, search engine 118 may include open source search engines, semantic browsing engines, social media search engines, meta search engines, visual search engines, search appliances, desktop search engines, any other suitable search engine or provider, or any suitable combination. For example, search engine 118 may include the online search engine Google. In an embodiment, search engine 118 may include electronic database 120. Electronic database 120 may include any suitable software for storing and manipulating data and may be coupled to memory, storage, or both as described with reference to electronic database 112.

Media content source 122 may include hardware, software, or both. In an embodiment, media content source 122 may include television broadcasters, cable providers, satellite providers, on-demand providers, Internet providers, distribution facilities, any other suitable media content providers, or any suitable combination. For example, media content source 122 may include the online video repository YouTube.

In an embodiment, media content source 122 may include electronic database 124. Electronic database 124 may include any suitable software for storing and manipulating data and may be coupled to memory, storage, or both as described with reference to electronic database 112. In an embodiment, media content source 122 may store media content in electronic database 124. For example, an online video may be stored in electronic database 124, any other suitable database, or any suitable combination.

In an embodiment, media content source 122 may be the originator of media content. For example, media content source 122 may include a television broadcaster or a Webcast provider. In another embodiment, media content source 122 may not be the originator of media content. For example, media content source 122 may include an on-demand media content provider or an Internet provider of downloadable video content.

In an embodiment, media content source 122 may include a remote media server used to store different types of media content, including video content selected by the user, in a remote database. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Distributed computing network 140 may be arranged in any suitable configuration, including, for example, a single geographic location, distribution amongst multiple geographic locations, any other suitable configuration or combination of components, or any suitable combination. In certain embodiments, search engine 118, media content source 122, any other suitable component, or any suitable combination may be part of a single installation or device, such as a single web site. For example, components 118 and 122 may be included in a single website, such as Metacafe. In certain embodiments, components 118, 122, any other suitable component, or any suitable combination may be implemented as separate components. For example, component 118 may be an Internet search engine and component 122 may be an online video repository.

Search engine 118 and media content source 122 are coupled to communications network 114 through communications paths 128 and 130, respectively. In an embodiment, search engine 118 and media content source 122 may be coupled to each other through communications path 126. In another embodiment, search engine 118 and media content source 122 may be coupled to each other through an indirect path via communications network 114. Search engine 118, media content source 122, or both may be coupled to event listings application 110, event promoter equipment device 102, event editor equipment device 104, server 142, any other suitable device, or any suitable combination via an indirect path via communications network 114, one or more communications paths such as those described with reference to communications paths 106 and 108, or both.

Communications paths 126, 128, and 130 may include any suitable communications paths, such as those described with reference to communications paths 106 and 108. Communications paths 126, 128, and 130 may be provided by one or more of these communications paths but are shown as single paths in FIG. 1 to avoid overcomplicating the drawing.

Search engine 118 may receive event information from events listings application 110, event promoter equipment device 102, event editor equipment device 104, any other suitable device, or any suitable combination via communications path 128. In an embodiment, the information may be stored in electronic database 120, any other suitable database, or any suitable combination. Search engine 118 may use the received event information to search for media content related to the event information using any suitable searching process. In an embodiment, search engine 118 may access media content source 122 via communications path 126 to locate media content.

Search engine 118 may receive event information input by the event promoter from event listings application 110. In an example, the received event information may include the event promoter “John Q. Smith,” the event name “Burbank High School vs. Pasadena High School Baseball Game,” the event venue “Burbank High School, 902 N Third St, Burbank, Calif. 91502,” the event schedule “Apr. 2, 2010 at 7:00 pm Pacific Daylight Time (PDT),” any other suitable event information, or any suitable combination. Search engine 118 may use any suitable portion of the received event information to search for online videos associated with the event information. For example, search engine 118 may query media content source 122 using the event title “Burbank High School vs. Pasadena High School Baseball Game” as a search expression to identify a previously recorded broadcast of a Burbank High School vs. Pasadena High School baseball game. Search engine 118 may transmit the identified media content (or a link to the identified media content) to event listings application 110 to allow the event promoter to select the media content to use as the background video displayed behind the foreground overlay of the event information. For example, search engine 118 may transmit a previously recorded broadcast of a Burbank High School vs. Pasadena High School baseball game, a previously recorded broadcast of a Burbank High School vs. Glendale High School baseball game, and a previously recorded broadcast of a Burbank High School vs. Pasadena High School basketball game to event listings application 110.

Event listings application 110 may provide the media content identified by search engine 118 to event promoter equipment device 102 in any suitable manner, such as in a list of media content, electronic text, graphic images, online videos, any other suitable listing, or any suitable combination. The event promoter may select one or more of the identified media content. For example, the event promoter may select the previously recorded broadcast of the Burbank High School vs. Glendale High School baseball game using event promoter equipment device 102.

Event listings application 110 may generate the integrated event listing based on the input received by the event promoter. For example, event listings application 110 may generate the integrated event listing by integrating the media content selected by the event promoter as background video displayed behind a foreground overlay of the text of the event information inputted by the event promoter.

In an embodiment, system 100 allows event promoters to generate integrated event listings in a cost-efficient manner by using information freely available to Internet users. For example, components 118, 122, any other suitable component, or any suitable combination may provide search services, online videos, or both at little or no cost. In an example, component 118 may be an open source online search engine and component 122 may be an open source online video repository.

In an embodiment, system 100 may include more than one of each of event listings application 110, search engine 118, media content source 122, any other suitable component, or any suitable combination. For example, system 100 may include one or more media content sources 132. One or more media content sources 132 may include any suitable software, hardware, or both and are referred to hereinafter as media content sources 132. In an embodiment, media content sources 132 may include one or more electronic databases 134, which are referred to hereinafter as electronic databases 134. Electronic databases 134 may include any suitable software for storing and manipulating data and may store or retrieve data from memory, storage, or both as described with reference to electronic database 112. In an embodiment, media content sources 132 may store media content in electronic databases 134. For example, an online video may be stored in electronic databases 134, any other suitable database, or any suitable combination.

In an embodiment, distributed computing network 140 may include additional components. For example, media content sources 132 may be included in distributed computing network 140. In an embodiment, additional components may be separate from distributed computing network 140 and may be coupled to distributed computing network 140 through communications path 138. For example, media content sources 132 may include a third-party website or database coupled to distributed computing network 140 through communications path 138. In an embodiment, additional components such as media content sources 132 may be coupled to communications network 114 through communications path 136. In an embodiment, additional components such as media content sources 132 may be coupled to event listings application 110, event promoter equipment device 102, event editor equipment device 104, search engine 118, media content source 122, server 142, any other suitable device, or any suitable combination through an indirect path via communications network 114, one or more communications paths such as those described with reference to communications paths 106 and 108, or both.

Communications paths 136 and 138 may include any suitable communications paths, such as those described with reference to communications paths 106 and 108. Communications paths 136 and 138 may be provided by one or more of these communications paths but are shown as single paths in FIG. 1 to avoid overcomplicating the drawing.

Server 142 may include any suitable hardware, software, or both. In an embodiment, server 142 may be a dedicated, client-oriented server. In an embodiment, server 142 may include one or more computers and may be coupled to communications network 114 through communications path 144. Communications path 144 may include any suitable communications paths, such as those described with reference to communications paths 106 and 108. Communications path 144 may be provided by one or more of these communications paths but is shown as a single path in FIG. 1 to avoid overcomplicating the drawing.

In an embodiment, server 142 may include electronic database 146. Electronic databases 146 may include any suitable software for storing and manipulating data and may be coupled to memory, storage, or both as described with reference to electronic database 112.

In an embodiment, server 142 may include electronic processing equipment 148. Electronic processing equipment 148 may include any suitable hardware, software, or both for processing data. For example, electronic processing equipment 148 may include processing circuitry, such as one or more microprocessors (e.g., dual-core Intel Xeon Processors), microcontrollers, digital signal processors, programmable logic devices, any other suitable device, or any suitable combination.

Communications between server 142, electronic database 146, and electronic processing equipment 148 may include any suitable communications paths, such as those described with reference to communications paths 106 and 108. Communications between server 142, electronic database 146, and electronic processing equipment 148 may be provided by one or more of these communications paths but are not shown in FIG. 1 to avoid overcomplicating the drawing.

In an embodiment, system 100 may allow for faster delivery, reduced bandwidth usage, or both by coupling server 142 to a dedicated electronic database. For example, server 142 may be coupled to integrated event listings database 150. Integrated event listings database 150 may include any suitable software for storing and manipulating data and may be coupled to memory, storage, or both as described with reference to electronic database 112. In an embodiment, databases 112, 146, and 150 may be provided as a single database.

In an embodiment, integrated event listings database 150 may be coupled to server 142 through communications path 152. Communications path 152 may include any suitable communications paths, such as those described with reference to communications paths 106 and 108. In an embodiment, integrated event listings database 150 may be coupled to server 142 through an indirect path via communications network 114. Communications path 152 may be provided by one or more of these communications paths but is shown as a single path in FIG. 1 to avoid overcomplicating the drawing.

In an embodiment, system 100 may store integrated event listings, event information, media content, any other suitable information, or any suitable combination in integrated event listings database 150. For example, the integrated event listing stored in integrated event listings database 150 may be available for download and display on user equipment 154 in response to the user selecting the integrated event listing. In another embodiment, system 100 may store integrated event listings, event information, media content, any other suitable information, or any suitable combination may be stored in electronic database 146, electronic database 112, electronic database 124, any other suitable storage location, or any suitable combination. For example, server 142 may integrate event information stored in electronic database 112 with an online video stored in electronic database 124 to generate the integrated event listing. In certain embodiments, server 142 may communicate an integrated event listing to user equipment 154 without storing some or all of the event information, the media content, or both in electronic database 146, integrated event listings database 150, or both. This may allow for faster delivery of the integrated event listing, reduced bandwidth usage, or both.

In an embodiment, system 100 may allow for ease of video and VOD delivery to a user equipment device by adapting server 142 to include a VOD pump for pumping data from server 142, integrated event listings database 150, or both to user equipment 154. In an embodiment, system 100 may implement event listings application 110 partially or wholly on server 142, and vice versa.

System 100 provides the event information and selected media content (e.g., individually or as an integrated event listing) to user equipment 154, which displays the event information and selected media content to the user. In an embodiment, server 142 may communicate integrated event listings to user equipment 154 through communications path 156, an indirect path via communications network 114, or both. User equipment 154 may include any suitable hardware, software, or both. In an embodiment, user equipment 154 includes user television equipment 158, user computer equipment 160, wireless user communications equipment 162, any other suitable device for displaying integrated event listings, or any suitable combination. In an embodiment, user equipment 154 may include a local client, such as a VOD client, EBIF client, TV widget, any other suitable client, or any suitable combination. For simplicity, these devices are referred to herein collectively as user equipment, user viewing equipment, or user equipment devices.

Communications paths 156 may include any of the communications paths described above in connection with communications paths 106 and 108 and may be exchanged over one or more communications paths, but is shown as a single path in FIG. 1 to avoid overcomplicating the drawing.

Although communications paths are not drawn between user equipment devices, user equipment devices 158, 160, 162, and 164 may communicate with each other via any of the communications paths described above in connection with communications paths 106 and 108. For example, wireless user communications equipment 162 may communicate with user computer equipment 160 via a free-space connections path (e.g., Bluetooth). In an embodiment, user equipment devices may be coupled to each other through one or more indirect paths via communications network 114.

User equipment devices 158, 160, 162, and 164 may communicate with server 142, communications network 114, or both via any of the communications paths described above in connection with communications paths 106 and 108. For example, user television equipment 158 may communicate with communications network 114 via a fiber-optic path. In another example, positioning equipment 164 may be coupled to communications network 114 via a wireless communications path. In an embodiment, user equipment devices may be coupled with server 142 through an indirect path via communications network 114.

User equipment 154 may function as a standalone device or may be part of a network of devices. For example, user equipment may be implemented in a dwelling, a vehicle (e.g., automobile, scooter, motorcycle, bicycle, airplane, boat, train, tram, or any other suitable vehicle), any other suitable stationary or mobile location, or any suitable combination. In an embodiment, one or more of these devices may be implemented as a single device.

In an embodiment, user equipment 154 may include user television equipment 158. User television equipment 158 may include hardware, software, or both. For example, user television equipment 158 may include one or more of the following devices: a display device or screen, a set-top box, an integrated receiver decoder (IRD) for handling satellite television, a VOD client, an EBIF client, a TV widget, a local media server, any other suitable equipment or client, or any suitable combination.

In an embodiment, user equipment 154 may include user computer equipment 160. User computer equipment 160 may include hardware, software, or both. For example, user computer equipment 160 may include one or more of the following devices: a display device or screen, a PC, a laptop, a tablet computer, an in-vehicle computer, a gaming computer, a personal computer television (PC/TV), a PC media server, a PC media center, any other suitable equipment, or any suitable combination.

In an embodiment, user equipment 154 may include wireless user communications equipment 162. Wireless user communications equipment 162 may include hardware, software, or both. For example, wireless user communications equipment 162 may include one or more of the following devices: a display device or screen, a PDA, a smartphone, a mobile telephone, an internet phone, a satellite phone, an in-vehicle phone or interface system, a digital camera, a portable video player, a portable music player, a portable gaming machine, a Wi-Fi enabled laptop, netbook, or tablet computer, a 3G (or other cellular network) enabled laptop, netbook, or tablet computer, any other suitable wireless device, or any suitable combination.

In an embodiment, user equipment 154 may include positioning equipment 164. Positioning equipment 164 may include any suitable hardware, software, or both for determining the geographic location of one or more user equipment devices. In an embodiment, positioning equipment 164 may be coupled to communications network 114, a cellular communications tower, a satellite communications tower, any other suitable component, or any suitable combination. For example, positing equipment 164 may determine that user equipment 154 is geographically located in Burbank, Calif. and communicate the determined geographic location of user equipment 154 to server 142. In response, server 142 may deliver the integrated event listing for an event located in nearby Los Angeles, Calif. to user equipment 154 geographically located in Burbank, Calif. Systems and methods for providing a television program guide with local information are discussed in greater detail in connection with Carr et al., U.S. Pat. No. 6,209,129, issued Mar. 27, 2001, which is hereby incorporated by reference herein in its entirety.

The integrated event listing may have the same layout on the various different types of user equipment or may be tailored to the display capabilities of the user equipment. For example, the integrated event listing may be provided as a television broadcast, VOD option, or both on user television equipment 158. In another example, the integrated event listing may be provided as a web site accessed by a web browser on user computer equipment 160. In another example, the integrated event listing may be provided in a scaled down format on wireless user communications equipment 162.

The event listings application, integrated event listings application, or both may be either partially or wholly implemented on any suitable component or combination of components described with connection to system 100. In an embodiment, the event listings application, integrated event listings application, or both may be stand-alone applications implemented on event promoter equipment device 102, event editor equipment device 104, user equipment 154, any other suitable component, or any suitable combination. For example, the event listings application may be implemented wholly on the processing equipment of event promoter equipment device 102, event editor equipment device 104, or both.

In an embodiment, the event listings application, integrated event listings application, or both may be a client-server application where the client is implemented on event promoter equipment device 102, event editor equipment device 104, user equipment 154, any other suitable component, or any suitable combination. For example, the event listings application may be implemented partially as a client application on the processing equipment of event promoter equipment device 102, event editor equipment device 104, or both and partially as a server application on a remote server, such as event listings application 110, server 142, any other suitable server, or any suitable combination.

In an embodiment, the integrated event listings application client implemented on user equipment 154 may initiate sessions with server 142, database 150, source 122, event listings application 110, any other suitable component, or any suitable combination to obtain integrated events listings.

In an embodiment, the integrated event listings application may provide user equipment 154 with display screens via server 142. In an embodiment, the integrated event listings may provide data from integrated event listings database 150 for storage on the user equipment 154. User equipment 154 may then generate the integrated event listings application display screens based on, for example, instructions processed by processing equipment.

System 100 is intended to illustrate a number of approaches by which event promoter and event editor equipment devices, user equipment devices, and other system components may be coupled to each other for the purpose of generating, managing, accessing, and providing the integrated event listing. The present disclosure may be used in any one or a subset of these approaches, or in a system employing other approaches for generating and providing the integrated event listing.

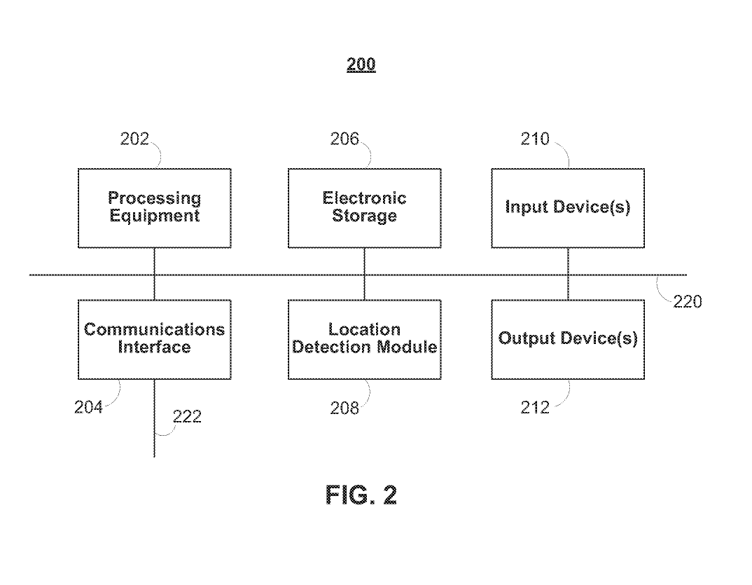

FIG. 2 is a block diagram of an illustrative equipment device 200 in accordance with some embodiments of the present disclosure. Equipment device 200 may be referred to as user equipment, a user device, a user equipment device, an event promoter equipment device, an event editor equipment device, or any other suitable nomenclature. Equipment device 200 is one example of a suitable architecture used in connection with partially or wholly implementing the event listings application, the integrated event listings application, or both having integrated event listings management capabilities. In an embodiment, other architectures may be used and may include more or fewer components than those illustrated.

Equipment device 200 may be used by the event promoter to generate the integrated event listing, by the event promoter to manage the integrated event listing, by the user to view the integrated event listing, or by any suitable combination. For example, event promoter equipment device 102, event editor equipment device 104, user equipment 154 shown in FIG. 1 may each include equipment device 200. In an embodiment, user equipment devices 158, 160, 162, and 164 may each include one or more of components 202, 204, 206, 208, 210, 212, 214, and 216 described with reference to equipment device 200.

Equipment device 200 may include hardware, software, or both. In an embodiment, equipment device 200 may include one or more of the following components: processing equipment 202, communications interface 204, electronic storage 206, location detection module 208, input device 210, output device 212, any other suitable component, or any suitable combination.

In an embodiment, components 202, 204, 206, 208, 210, 212, any other suitable component, or any suitable combination may be part of a single installation or device, including but not limited to: a personal computer, a laptop, a tablet computer, an in-vehicle computer, a gaming computer, a personal computer television (PC/TV), a PC media server, a PC media center, a game console or device, an email device, a personal digital assistant, a smartphone, a mobile telephone, an internet phone, a satellite phone, a portable video player, a portable music player, a portable gaming machine, a Wi-Fi enabled laptop, netbook, or tablet computer, a 3G (or other cellular network) enabled laptop, netbook, or tablet computer, any other suitable device, or any suitable combination.

For example, equipment device 200 may be a tablet computer running on the Internet.

In an embodiment, components 202, 204, 206, 208, 210, 212, any other suitable component, or any suitable combination may be implemented as separate devices. For example, components 208, 210, and 212 may be included in a smartphone while components 202, 204, and 206 may be included in a PC/TV.

Components 202, 204, 206, 208, 210, 212, any other suitable component, or any suitable combination may exchange communications and data over communications path 220, which may be any suitable wired, wireless, or both path and which may use any suitable hardware, software, or both for facilitating the transfer of data and control signals between components. Communications path 220 may include any suitable communications paths, such as those described with reference to communications paths 106 and 108 shown in FIG. 1. Communications path 220 may be provided by one or more of these communications paths but is shown as a single path in FIG. 2 to avoid overcomplicating the drawing.

Processing equipment 202 may include any suitable software, hardware, or both for processing data. For example, processing equipment 202 may include processing circuitry, such as one or more microprocessors, microcontrollers, digital signal processors, programmable logic devices, any other suitable device, or any suitable combination. In an embodiment, processing equipment 202 may execute instructions for an application (e.g., an event listings application, an integrated event listings application, a web browser application, any other suitable application, or any suitable combination) stored in electronic storage 206, any other suitable storage, or any suitable combination.

In an embodiment, processing equipment 202 may include circuitry suitable for communicating with event listings application 110, communications network 114, server 142, any other suitable networks or servers, or any suitable combination. In an embodiment, communications circuitry may be represented as communications interface 204 and may be coupled to other components, networks, or both through communications path 222. Communications circuitry may include, for example, a cable modem, an integrated services digital network (ISDN) modem, a digital subscriber line (DSL) modem, a telephone modem, a wireless modem, any other suitable communications device, or any suitable combination for communications with other equipment. In an embodiment, communications circuitry may include circuitry that enables peer-to-peer communication of equipment devices, communication of equipment devices in locations remote from each other, or both.

Communications path 222 may include one or more communications paths, such as paths described with reference to communications paths 106 and 108 shown in FIG. 1. Communications path 222 may be provided by one or more of these communications paths, but is shown as a single path in FIG. 2 to avoid overcomplicating the drawing.

In an embodiment, processing equipment 202 may include video generating circuitry and tuning circuitry. For example, processing equipment 202 may include one or more analog tuners, digital decoders, MPEG-2 decoders, high-definition tuners, any other suitable tuning or video circuits, or any suitable combination. In an embodiment, processing equipment 202 may include encoding circuitry for converting over-the-air, analog, or digital signals to MPEG signals for storage. In an embodiment, processing equipment 202 may include scaler circuitry for upconverting and downconverting media content into a preferred output format of equipment device 200. In an embodiment, processing equipment 202 may include digital-to-analog converter circuitry and analog-to-digital converter circuitry for converting between digital and analog signals.

Electronic storage 206 may include any suitable hardware, software, or both for storing data. For example, electronic storage 206 may include memory (e.g., random-access memory, read-only memory, any other suitable memory, or any suitable combination), hard drives, optical drives, nonvolatile memory, any other suitable fixed or removable storage devices (e.g., DVD recorder, CD recorder, video cassette recorder, or other suitable recording device), or any suitable combination. In an embodiment, electronic storage 206 may include one or more of the above types of storage devices. For example, equipment device 200 may include a digital video recorder (DVR) as a primary storage device and a DVD recorder as a secondary storage device.

Electronic storage 206 may be used to store various types of media described herein with reference to the event listings application and the integrated event listings application, such as: event information; media content; integrated event listings; event listings application settings; integrated event listings application settings; event promoter preferences; event promoter profile information; event editor preferences; event editor profile information; user preferences; user profile information; any other suitable data; or any suitable combination.

Location detection module 208 may include any suitable hardware, software, or both for determining the geographic location of equipment device 200. For example, location detection module 208 may include a satellite positioning system (e.g., GPS), antenna triangulation system, Wi-Fi capability, any other suitable hardware, software, or both, or any suitable combination. In an embodiment, location detection module 208 may be used to provide geographic location information to positioning equipment 164 shown in FIG. 1 via communications path 222.

For purposes of clarity, and not by way of limitation, the location determining features of the present disclosure with respect to equipment devices will be referred to herein as a location detection module (e.g. location detection module 208), a location detection computing device, or a location detection adapter. It will be understood that this term refers not only to global positioning satellite systems but also to other types of positioning systems, such as regional satellite systems, antenna triangulation, location tracking via Internet protocol (IP) address, any other suitable location determining mechanism, or any suitable combination. In an embodiment, integrated event listings may be provided to a user equipment device based upon the geographic location of the user equipment device.

Equipment device 200 may include input device 210, output device 212, any other suitable device, or any suitable combination to provide for interaction with the event promoter, the event editor, or the user. In an embodiment, input device 210, output device 212, or both may be provided as stand-alone devices or integrated with other elements of equipment device 200.

Input device 210 may include hardware, software, or both. For example, input device 210 may include any suitable device or interface, such as a remote control, mouse, trackball, keypad, keyboard, touch screen, touch pad, stylus input, joystick, microphone, voice recognition interface, any other suitable input device or interface, or any suitable combination. For example, input device 210 may include a computer keyboard and mouse.

In an embodiment, input device 210 may be used to provide input data to processing equipment 202, any other suitable component, or any suitable combination. For example, input device 210 may provide access to or the ability to generate the integrated event listing by integrating an online video and the text of an event listing in response to the event promoter selecting a selectable option provided in a display screen, such as a selectable media content listing.

In an embodiment, input device 210 may provide access to or the ability to generate the integrated event listing by integrating an online video and the text of an event listing in response to the event promoter pressing a dedicated button (e.g., a key on a keyboard, a mouse button, a soft key, any other suitable button, or any suitable combination). For example, an integrated event listing may be stored in integrated event listings database 150 in response to an event promoter pressing the left mouse button on a computer mouse.

In an embodiment, input device 210 may provide access to or the ability to generate the integrated event listing by integrating an online video and the text of an event listing in response to the event promoter making a selection, inputting data, or both using a touchscreen, voice command, any other suitable option, or any suitable combination. For example, an integrated event listing may be stored in integrated event listings database 150 in response to an event promoter saying “save” into a microphone, voice recognition interface, or both.

Output device 212 may include hardware, software, or both. Output device 212 may include one or more of a monitor, a television, a liquid crystal display (LCD), a cathode ray tube (CRT) device, any other suitable equipment for providing visual images, or any suitable combination. For example, output device 212 may be a smartphone display screen.

In an embodiment, one or more audio speakers may be provided to output the audio component of integrated event listings and other media content. In an embodiment, audio speakers may be provided as integrated with other elements of equipment device 200, such as output device 212. For example, output device 212 may be a television with integrated speakers. In an embodiment, audio speakers may be provided as stand-alone units. For example, audio signals may be distributed to a receiver, which may process and output the audio signals via stand-alone audio speakers.

In an embodiment, the integrated event listings application may be downloaded, interpreted, or otherwise processed by an interpreter or virtual machine. For example, processing equipment 202 may download and process the integrated event listings application.

In an embodiment, the integrated event listings application may be encoded in the ETV Binary Interchange Format (EBIF), received by processing equipment 202 as part of a suitable feed, and interpreted by an agent running on processing equipment 202. For example, the integrated event listings application may be an EBIF widget.

In an embodiment, the integrated event listings application may be defined by a series of JAVA-based files that are received and run by a local virtual machine or other suitable middleware executed by processing equipment 202. For example, the integrated event listings application may be encoded and transmitted in an MPEG-2 object carousel with the MPEG audio and video packets of a program in embodiments using MPEG-2 or other digital media encoding schemes. The integrated event listings application may also use any other suitable interactive television application, computer application, wireless device application, or any suitable combination.

Illustrative display screens of the event listings application and the integrated event listings application are discussed in reference to FIGS. 3-6.

FIG. 3 shows an illustrative event listings application display screen 300 for inputting event information in accordance with some embodiments of the present disclosure. In an embodiment, the event listings application may provide access to any suitable type of content in a single display, a single screen overlay over media content being displayed, multiple displays, multiple screen overlays over media content being displayed, any other suitable display, or any suitable combination and may be updated at any suitable time interval.

The event listings application provides access to or the ability to add information associated with the integrated event listing to any suitable database (e.g., database 112, 146, and 150 shown in FIG. 1). For example, display screen 300 may include one or more individually selectable fields 302, such as event name, presenter name, event description, event schedule, venue name, venue address, ticket information, promoter name, promoter contact information, additional information or comments, any other suitable field, or any suitable combination for use in generating an integrated event listing in accordance with some embodiments of the present disclosure.

The event listings application allows the event promoter to input event information and select media content via selectable fields 302. In an embodiment, the event listings application may provide data entry capability via selectable field 304 (e.g., “Presenter Name”). For example, input device 210 shown in FIG. 2 may be used to select selectable field 304 and input event information associated with selectable field 304.

The event listings application may allow the event editor to edit event information, media content, and the integrated event listing via selectable fields 302. The event listings application may provide data editing capability via selectable field 304. In an embodiment, input device 210 shown in FIG. 2 may be used to select and edit event information associated with selectable field 304. For example, the event listings application may reformat integrated event listings with presenter names “John Smith”, “John Q. Smith”, and “johnsmith” to have the presenter name “Smith, John Q.” in response to event editor actions, preferences, or both.

The event listings application may store information associated with selectable fields 302, any other suitable information, or any suitable combination in a database. For example, the event listings application may store information associated with selectable field 304 in electronic database 112 shown in FIG. 1 for use in generating the integrated event listing. In an embodiment, the event listings application may store information associated with selectable fields 302, any other suitable information, or any suitable combination in integrated event listings database 150 shown in FIG. 1 for use in providing the integrated event listing to the user via server 142 shown in FIG. 1.

In an embodiment, the event listings application may provide a confirmation region. The confirmation region may be, for example, a single display region, a single screen overlay region, multiple display regions, multiple screen overlay regions, any other suitable display, or any suitable combination. In an embodiment, the confirmation region may be accompanied by affirmative confirmation option 306 (e.g., “Save”), negative confirmation option 308 (e.g., “Cancel”), any other suitable feature or option, or any suitable combination.

When affirmative confirmation option 306 is selected by the event promoter, the event listings application may store information associated with selectable fields 302, any other suitable information, or any suitable combination in a database. For example, the event listings application may store information associated with an event listing in electronic database 112 shown in FIG. 1 for use in providing online video recommendations to event promoter equipment device 102 shown in FIG. 1. In an embodiment, the event listings application may store information associated with selectable fields 302, any other suitable information, or any suitable combination in electronic database 146, integrated event listings database 150 shown in FIG. 1, or both for use in generating integrated event listings.

In an embodiment, the event listings application may periodically store event information in any suitable temporary storage device (e.g., database 112, database 146 shown in FIG. 1, storage 206 shown in FIG. 2) without receiving confirmation by the event promoter or the event editor. The event listings application may delete event information from the temporary storage device, return the display screen to an earlier state, or both in response to the event promoter or the event editor selecting, for example, negative confirmation option 308.

Display screen 300 may include an informational header, which may be used to display information, date, time, location, calendar, weather, any other suitable information, or any suitable combination in textual or multimedia formats. For example, the event listings application may provide informational header 310 (e.g., “Submit Event Information”). In another example, the event listings application may provide informational header 310 (e.g., “Edit Event Information Portion of Integrated Event Listing”).

Display screen 300 may include one or more display regions, one or more advertisements, one or more options regions, any other suitable region, or any suitable combination. In an embodiment, display screen 300 may be personalized in accordance with some embodiments of the present disclosure. It will be appreciated that the aforementioned features may be included in other display screens of the present disclosure.

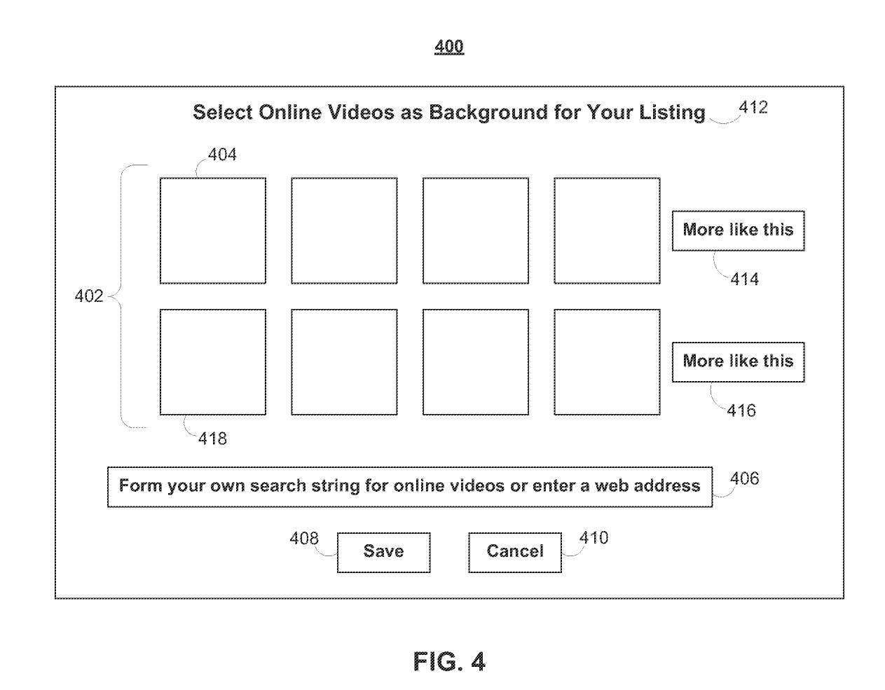

FIG. 4 shows an illustrative event listings application display screen 400 for selecting media content in accordance with some embodiments of the present disclosure. It will be appreciated that the features described with reference to display screen 400 may be included in other display screens of the present disclosure.

The event listings application provides access to or the ability to generate the integrated event listing by, for example, adding media content associated with an event listing to any suitable database. For example, the event listings application may add the online video selected by the event promoter to the information about the event by storing the online video in database 112, 146, 150 shown in FIG. 1, any other suitable database, or any suitable combination in response to event promoter or event editor actions.

The event listings application uses any suitable search engine (e.g., search engine 118 shown in FIG. 1), search process or both to search any suitable media content stored in any suitable media content source (e.g., media content source 122, 132 shown in FIG. 1) to identify media content listings. The searching process may be based on, for example, search parameters associated with the event information.

The event listings application, search engine, or both may use electronic processing equipment to generate search parameters (e.g., keywords, search strings, any other suitable data, or any suitable combination) by extracting names of people, events, titles, locations, and organizational names, any other suitable information, or any suitable combination from the text of the event information. For example, the event promoter may use a web browser running on a computer to input the event information “The entire Labor Day weekend at the Mariott Los Angeles Airport hotel is given over to the Sweet & Hot Jazz Festival, honoring the greats with tunes from modern-day masters including the Jack Sheldon Big Band, Tommy Saunders, Howard Alden, Bucky Pizzarelli, Yve Evans, Ava Dupree and hundreds of other performers appearing on eight different stages.” Event listings application 110 (FIG. 1) receives the event information input by the event promoter through communications path 106 and uses processing equipment 202 to generate the search expressions “Jack Sheldon Big Band,” “Tommy Saunders,” and “Howard Alden” from the received event information for use in any suitable search process (e.g., Boolean search, meta search, query expansion).

The event listings application, search engine, or both may use electronic processing equipment to identify media content associated with the event information by accessing and searching media collections using the generated search expressions. For example, event listings application 110, search engine 118, or both (FIG. 1) may access and search media content source 122 using the generated search expression “Jack Sheldon Big Band” to identify online music videos associated with the musical ensemble Jack Sheldon Big Band. The event listings application may communicate the identified online videos to event promoter equipment device 102 shown in FIG. 1 as a list of identified media content.

The event listings application displays the list of identified media content as media content listings 402 in display screen 400. Media content listings 402 may provide text, icons, graphical images (e.g., cover art, still images from the media content), audio, video, video clip previews, any other suitable type of media indicative of the media content, or any suitable combination. For example, the event listings application may provide one or more graphical images accompanied by text indicative of the identified media content.

In an embodiment, the event listings application may organize media content listings 402 based on the search expressions. For example, the row of media content listings beginning with media content listing 404 may include text indicating that these media content listings were identified in a search using the text of the event name as a search expression. In another example, the row of media content listings beginning with media content listing 418 may include text indicating that these media content listings were identified in a search using one or more search expressions generated from the names of people in the event description. In an embodiment, additional media content results for a given search may be accessed using selectable feature 414 (e.g., “more like this”), selectable feature 416 (e.g., “more like this”), any other suitable feature, or any suitable combination.

In an embodiment, media content listings 402 may vary in size to indicate varying degrees of interest or relevancy or to emphasize certain content, as desired by the media provider, search provider, user preferences, any other suitable entity, or any suitable combination. For example, the event listings application may determine that media content listing 404 is more relevant to the event information than media content listing 418 and display media content listing 404 as larger in size than media content listing 418 based on the higher degree of relevance of media content listing 404.

In an embodiment, media content listings 402 may be graphically accentuated to indicate degrees of interest to the user or to emphasize certain content, as desired by the media provider, search provider, user preferences, any other suitable entity, or any suitable combination. For example, the event listings application may determine that media content listing 404 is more relevant to the event information than media content listing 418 and display media content listing 404 with a highlighted border and media content listing 418 without a highlighted border based on the higher degree of relevance of media content listing 404.

In an embodiment, the event promoter may select one or more media content listings to be integrated with the event information to generate the integrated event listing. For example, the event listings application may integrate media content associated with media content listing 404 and event information received with reference to display screen 300 shown in FIG. 3 to generate the integrated event listing in response to the event promoter selecting media content listing 404 using input device 210 shown in FIG. 2.

In an embodiment, the event promoter may request additional media content associated with specific event information, media content listings, or both. For example, the event listings application may provide additional media content associated with media content listing 418 in response to the event promoter selecting selectable feature 416 using input device 210 shown in FIG. 2.

In certain embodiments, the event promoter may seek clearance to generate the integrated event listing. For example, event listings application 110 (FIG. 1) may prompt the event promoter to send an electronic communication (e.g., an email) to the copyright owner of the video selected by the event promoter. The electronic communication may ask for permission to use the copyrighted video by asking “Are you aware that this video is on the internet and do you authorize the use of this video in an event listing for [event name] being promoted by [promoter name]?”, stating “Please email [promoter name] at [promoter email address] if you authorize the use of this video in an event listing for [event name].”, or communicating any other suitable question or statement. The event promoter may edit the text of the communication and send the communication to the copyright owner of the selected video using input device 210 (FIG. 2). If an affirmative response (e.g., replying to the email with “Yes” or “O.K.”, selecting a “yes” voting icon) is received from the copyright owner, the selected video may be used. If a negative response (e.g., replying to the email with “No”, selecting a “no” voting icon) is received from the copyright owner, event listings application 110 (FIG. 1) may prompt the event promoter to select an alternate video.

In an embodiment, the event promoter may enter a custom search string in selectable field 406 (e.g., “Form your own search string for online videos or enter a web address”) instead of, or in addition to, the search expressions generated by the event listings application. For example, the event promoter may enter a web address in selectable field 406 using input device 210 shown in FIG. 2 in order to acquire a known video for use in the integrated event listing. A known video may include, for example, a video that the event promoter has prepared and uploaded to the internet, a private network, or both.

In an embodiment, the event listings application may generate a degree of success for various search parameters. For example, the event listings application, search engine, or both may process search parameters associated with event information, such as event name (e.g., “Sweet & Hot Jazz Festival”), presenter name (e.g., “John Q. Smith”), and venue name (e.g., “Marriott Los Angeles Airport Hotel”). When there is a lack of media content related to specific search parameters, display screen 400 may include text indicative of the lack of media content related to the search parameters, such as “No online videos were found searching for presenter name ‘John Q. Smith’ and venue name ‘Marriott Los Angeles Airport Hotel’ as complete strings.”

In an embodiment, the event listings application may store information associated with media content listings 402, selectable field 406, any other suitable information, or any suitable combination in a database. For example, the event listings application may store information associated with selectable field 406 in electronic database 112 shown in FIG. 1 for use in providing the media content listing.

In an embodiment, the event listings application may store information associated with media content listings 402, selectable field 406, any other suitable information, or any suitable combination in electronic database 146, integrated event listings database 150, or both for use in generating the integrated event listing.

In an embodiment, the event listings application may provide a confirmation region. For example, the confirmation region may be accompanied by affirmative confirmation option 408 (e.g., “Save”), negative confirmation option 410 (e.g., “Cancel”), any other suitable feature or option, or any suitable combination.

When affirmative confirmation option 408 is selected by the event promoter, the event listings application may store information associated with one or more media content listings, any other suitable information, or any suitable combination in a database. For example, the event listings application may store an online video associated with media content listing 404 in integrated event listings database 150 for use in generating the integrated event listing.

In an embodiment, the event listings application may periodically store media content information in any suitable temporary storage device (e.g., database 112, database 146 shown in FIG. 1, storage 206 shown in FIG. 2) without receiving confirmation by the event promoter or the event editor. The event listings application may delete event information from the temporary storage device, return the display screen to an earlier state, or both in response to the event promoter or the event editor selecting, for example, negative confirmation option 410.

In an embodiment, display screen 400 may include an informational header, which may be used to display information, date, time, location, calendar, weather, any other suitable information, or any suitable combination in textual or multimedia formats.

For example, the event listings application may provide informational header 412 (e.g., “Select Online Videos as Background for Your Listing”). In another example, the event listings application may provide informational header 412 (e.g., “Edit Online Video Portion of Integrated Event Listing”).

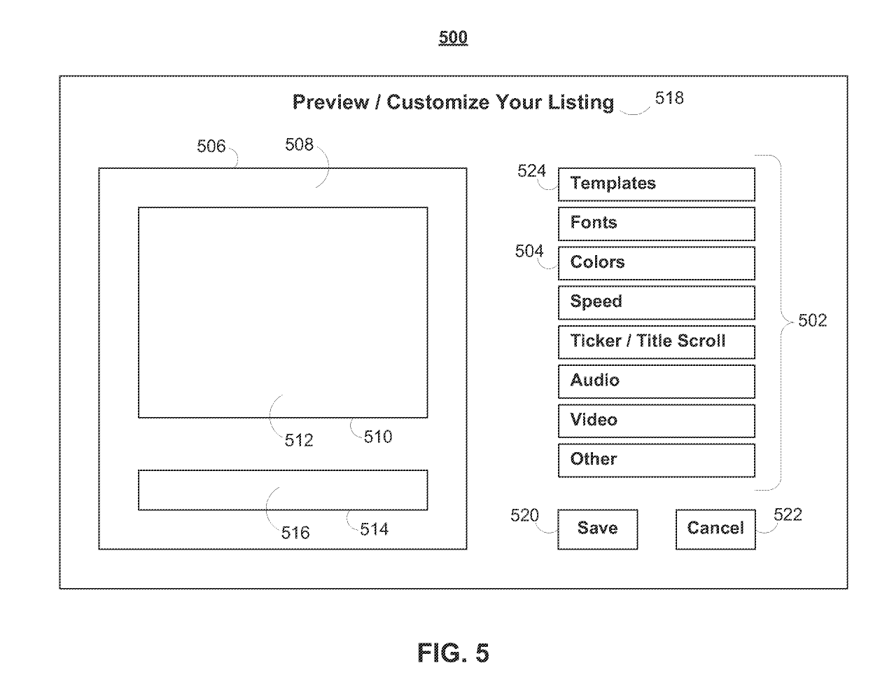

FIG. 5 shows an illustrative event listings application display screen 500 for managing the integrated event listing in accordance with some embodiments of the present disclosure. It will be appreciated that the features described with reference to display screen 500 may be included in other display screens of the present disclosure.

The event listings application provides display screen 500 to allow the event promoter, the event editor, or both to preview and manage the integrated event listing that has been generated by integrating the event information received with reference to display screen 300 shown in FIG. 3 with the media content associated with the one or more selected media content listings received with reference to display screen 400 shown in FIG. 4. For example, the event listings application may provide the capability to customize the speed, color, font, and size of textual event information included in the integrated event listing. The event listings application may store customizations to the integrated event listings in, for example, database 112, 146, 150 shown in FIG. 1, any other suitable database, or any suitable combination in response to event promoter or event editor actions.

The event listings application provides selectable options 502 in display screen 500. Selectable options 502 provide individually selectable options for use in customizing an integrated event listing, to include: templates, fonts, colors, speed, ticker or title scroll, audio, video, any other suitable option, or any suitable combination. For example, the event listings application may provide selectable option 504 (e.g., “Colors”), which provides the capability to customize the color of text, video, or both in an integrated event listing in response to event promoter or event editor actions.

The event listings application displays a preview of the integrated event listing in display region 506. For example, the event listings application may display media content associated with one or more selected media content listings as video behind scrolling textual event information underscored by the video's audio track.

Media content associated with the one or more media content listings selected with reference to display screen 400 shown in FIG. 4 are displayed in display region 508. For example, an online video associated with media content listing 404 shown in FIG. 4 may be displayed as background for an integrated event listing in display region 508.

In an embodiment, media content displayed in display region 508 may be customized in response to the event promoter, the event editor, or both selecting one or more selectable options. For example, input device 210 shown in FIG. 2 may be used to select selectable option 504, which may provide the capability to customize the color of an online video displayed in display region 508 from, digital 16-bit color to digital sepia-toned color or digital black and white.

Event information may be displayed in title scroll region 510, ticker scroll region 514, or both. For example, textual event information received with reference to display screen 300 shown in FIG. 3 may be displayed as scrolling foreground text for an integrated event listing in display region 508. In an embodiment, event information displayed in title scroll region 510 (e.g., title scroll event text 512), ticker scroll region 514 (e.g., ticker scroll event text 516), any other suitable information, or any suitable combination may be customized in response to an event promoter, event editor, or both selecting one or more selectable options. For example, input device 210 shown in FIG. 2 may be used to select selectable option 504, which may provide the capability to customize the color of title scroll event text 512 from, for example, black to red. In an embodiment, title scroll region 510, ticker scroll region 514, or both may be transparent with title scroll event text 512, ticker scroll event text 516, or both displayed as scrolling text overlaying display region 508.

In an embodiment, the event listings application may enable the management of the integrated event listing through the use of templates. For example, the event listings application may initially display the integrated event listing preview in display region 506 in a default template, such as title scroll event text 512 displayed in 12 point, black Arial font overlaying the online video displayed in display region 508.

In an embodiment, the event listings application may provide alternative templates in response to the event promoter or the event editor selecting selectable option 524 (e.g., “Templates”). For example, an alternative template may include ticker scroll event text 516 in 16 point, red Courier New font overlaying a sepia-toned online video displayed in display region 508. An alternative template may also include, for example, title scroll event text 512 in 24 point, yellow Times font overlaying a solid color background, such as a blue background.

In an embodiment, display screen 500 may include options for advertizing, formatting, censoring, any other suitable option, or any suitable combination. For example, the event listings application may enable preferential placement in listing menus, the sale of air time on cable channels, any other suitable advertising opportunity, or any suitable combination in response to an event promoter, event editor, or both providing any suitable input, such as billing account information, via a selectable advertising option. The event listings application may enable conformation of integrated event listings to VOD standards, for example, in response to the event promoter, the event editor, or both providing any suitable input via a selectable formatting option. The event listings application may enable compliance with television content ratings standards, for example, in response to the event promoter, the event editor, or both providing any suitable input via a selectable censoring option.

In an embodiment, the event listings application may store information associated with the integrated event listing, any other suitable information, or any suitable combination in a database. For example, the event listings application may store information associated with selectable options 502 in electronic database 112 shown in FIG. 1 for use in managing the integrated event listing. This information may be stored in, for example, customization databases, such as template databases, font databases, color databases, any other suitable database, or any suitable combination.

In an embodiment, the event listings application may store information associated with selectable options 502, any other suitable information, or any suitable combination in electronic database 146, integrated event listings database 150 shown in FIG. 1, or both for use in generating the integrated event listing.

In an embodiment, the event listings application may provide a confirmation region. The confirmation region may be accompanied by affirmative confirmation option 520 (e.g., “Save”), negative confirmation option 522 (e.g., “Cancel”), any other suitable feature or option, or any suitable combination.

When affirmative confirmation option 520 is selected by the event promoter, the event listings application may store information associated with the integrated event listing, any other suitable information, or any suitable combination in a database. For example, the event listings application may store the customized integrated event listing in integrated event listings database 150 shown in FIG. 1.

In an embodiment, the event listings application may periodically store information in any suitable temporary storage device (e.g., database 112, database 146 shown in FIG. 1, storage 206 shown in FIG. 2) without receiving confirmation by the event promoter or the event editor. The event listings application may delete event information from the temporary storage device, return the display screen to an earlier state, or both in response to the event promoter or the event editor selecting negative confirmation option 522.

In an embodiment, display screen 500 may include an informational header, which may be used to display information, date, time, location, calendar, weather, any other suitable information, or any suitable combination in textual or multimedia formats. For example, the event listings application may provide informational header 518 (e.g., “Preview/Customize Your Listing”). In another example the event listings application may provide informational header 518 (e.g., “Edit Integrated Event Listing”).

The event listings application allows the event promoter or the event editor to navigate between various events listings application display screens (e.g., display screen 300 shown in FIG. 3, display screen 400 shown in FIG. 4, display screen 500 shown in FIG. 5). In an embodiment, the event listings application may advance from one display screen to another display screen in response to an event promoter or event editor selecting a selectable feature. For example, the event listings application may progress from display screen 400 shown in FIG. 4 to display screen 500 shown in FIG. 5 in response to an event promoter or event editor selecting affirmative confirmation option 408 shown in FIG. 4. In another example, the event listings application may progress from display screen 500 to display screen 400 in response to an event promoter or event editor selecting negative confirmation option 522 shown in FIG. 5.

In an embodiment, the event listings application may provide navigational controls via selectable graphical user interface (GUI) buttons or icons, to include a back button, forward button, reload button, cancel or stop button, close button, minimize button, maximize button, any other suitable button or icon, or any suitable combination.

FIG. 6 shows an illustrative integrated event listings application display screen 600 for displaying the integrated event listing in accordance with some embodiments of the present disclosure. Display screen 600 enables the user to access to various types of integrated event listings in a single display, a single screen overlay over media content being displayed, multiple displays, multiple screen overlays over media content being displayed, any other suitable display, or any suitable combination. Display screen 600 may be updated at any suitable time interval defined by the integrated event listings application, user equipment 154 shown in FIG. 1, a distribution facility, any other suitable means, or any suitable combination. For example, display screen 600 may be updated at a rate of 60 Hz, 120 Hz, or any other suitable frequency.

The integrated event listings application provides selectable options 602 for viewing integrated event listings. In an embodiment, selectable options 602 may include options associated with providing integrated event listings for music events, sporting events, theatre events, speaking events, family events, miscellaneous events, one or more maps, any other suitable option such as the ability to submit an event or generate an integrated event listing, or any suitable combination.

The integrated event listings application may provide one or more integrated event listings in display region 606 in response to the user selecting one or more selectable options 602. For example, the integrated event listings application may provide integrated event listings for sporting events in display region 606 in response to the user selecting selectable option 604 (e.g., “Sporting Events”) using input device 210 shown in FIG. 2.

The integrated event listings application provides the integrated event listing in display region 606. For example, the integrated event listings application may provide video content in region 610 and overlaying event text in title scroll region 612, ticker scroll region 616, or both. In an embodiment, title scroll region 612, ticker scroll region 616, or both may be transparent with title scroll event text 614, ticker scroll event text 618, or both overlaying the media content displayed in region 610.

In an embodiment, the integrated event listings application may provide an informational header in display region 606 which may describe the scope of the displayed integrated event listings. For example, the integrated event listings application may provide informational header 608 (e.g., “Sporting Events for Los Angeles, Calif.”) in accordance with some embodiments of the present disclosure.

In an embodiment, display screen 600 may include informational header 630, which may be used to display information, date, time, location, calendar, weather, any other suitable information, or any suitable combination in textual or multimedia formats.

In an embodiment, display region 606 may include one or more individually selectable portions to view content related to event text 614, 618, media content 610, any other suitable content, or any suitable combination in accordance with some embodiments of the present disclosure. For example, the integrated event listings application may provide additional media content, additional integrated event listings, additional event calendars, any other suitable information, or any suitable combination in response to a user using input device 210 shown in FIG. 2 to select event text 614, 618, media content 610, any other suitable content, or any suitable combination.

In an embodiment, the integrated event listings application may provide a map showing the geographic location of the event, the user, directions from the user to the event, any other suitable information, or any suitable combination in response to the user selecting selectable option 620 (e.g., “Map”).

In an embodiment, the integrated event listings application may enable the user to become the event promoter and generate the integrated event listing with minimal difficulty. For example, the integrated event listings application may provide access to the event listings application in response to the user selecting selectable option 622 (e.g., “Submit Event”).

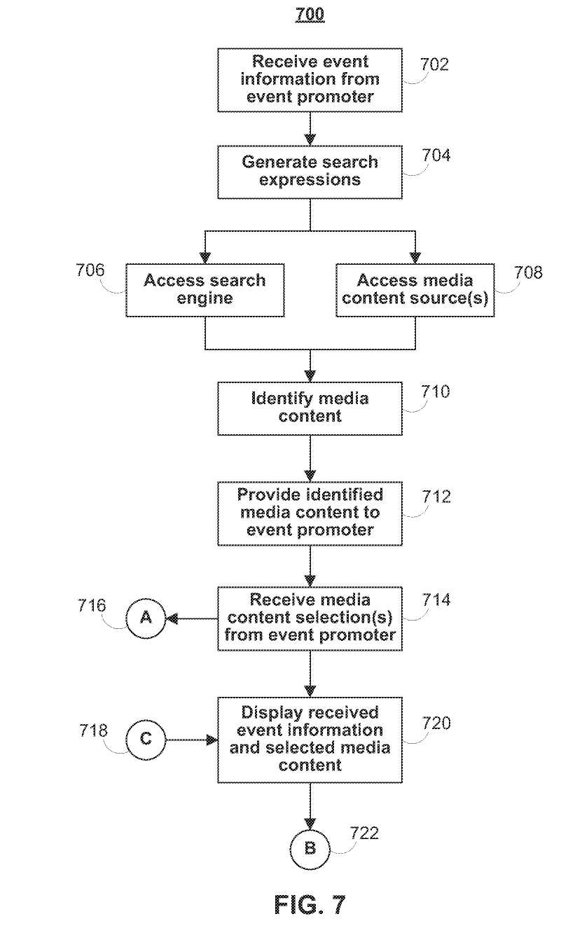

FIG. 7 is a flow chart of illustrative steps 700 involved in generating the integrated event listing in accordance with some embodiments of the present disclosure.

At step 702, the event listings application receives event information input by the event promoter through any suitable communications path, network, or both. For example, event listings application 110 shown in FIG. 1 may receive event information from event promoter equipment device 102 through communications path 106. The event information may include an event name, presenter name, event description, event schedule, venue name, venue address, ticket information, promoter name, promoter contact information, any other suitable field, or any suitable combination inputted by the event promoter in selectable fields 302 shown in FIG. 3 using input device 210 shown in FIG. 2. In an example, the received event information may include the event promoter “John Q. Smith,” the event name “Burbank High School vs. Pasadena High School Baseball Game,” the event venue “Burbank High School, 902 N Third St, Burbank, Calif. 91502,” the event schedule “Apr. 2, 2010 at 7:00 pm Pacific Daylight Time (PDT),” any other suitable event information, or any suitable combination.

At step 704, the event listings application uses electronic processing equipment to generate search expressions from the received event information. In an embodiment, event listings application 110 shown in FIG. 1 may generate search expressions by extracting names of people, events, titles, locations, organizational names, any other suitable parameters, or any suitable combination from the event information using processing equipment 202 shown in FIG. 2. For example, the generated search expressions may be generated from the event name (e.g., “Burbank High School vs. Pasadena High School Baseball Game”), event promoter (e.g., “John Q. Smith”), venue name (e.g., “Burbank High School, 902 N Third St, Burbank, Calif. 91502”), any other suitable event information, or any suitable combination.

In an embodiment, the event listings application may process the generated search expressions using any suitable search process. For example, event listings application 110 shown in FIG. 1 may process the generated search expressions to generate variations or permutations of the generated search expressions. In an embodiment, the event listings application may use syntactic analysis to process the event information. For example, event listings application 110 shown in FIG. 1 may identify alphabetic strings with sequential capitalized words to find proper nouns (e.g., “Burbank High School”), names of people (e.g., “John Q. Smith”), or both in the text of the event information to use as keywords or other suitable search parameters. In an embodiment, the event listings application may revise the generated search expressions. For example, event listings application 110 shown in FIG. 1 may revise the generated search expression “Burbank HS vs. Pasadena HS BG” to generate the revised search expression “Burbank High School versus Pasadena High School Baseball Game” by comparing the identified strings with lists of common names.

At step 706, the event listings application accesses a search engine through any suitable communications path, network, or both for use in identifying media content associated with the search expressions generated from the received event information. For example, event listings application 110 shown in FIG. 1 may access search engine 118 via communications network 114.

At step 708, the event listings application accesses one or more media content sources through any suitable communications path, network, or both for use in identifying media content associated with the search expressions generated from the received event information. For example, event listings application 110 shown in FIG. 1 may access media content source 122, 132, or both via communications network 114.

At step 710, the event listings application uses the search engine to identify media content using the generated search expressions. For example, search engine 118 shown in FIG. 1 may access and search media content source 122 using the search expression “Burbank High School versus Pasadena High School Baseball Game” to identify a previously recorded broadcast of a Burbank High School vs. Pasadena High School baseball game, a previously recorded broadcast of a Burbank High School vs. Glendale High School baseball game, and a previously recorded broadcast of a Burbank High School vs. Pasadena High School basketball game.

At step 712, the event listings application provides the identified media content to the event promoter to allow the event promoter to select the media content to be used in generating the integrated event listing (e.g., the video to be displayed as background video behind a foreground overlay of the event information). For example, event listings application 110 may communicate the identified media content to event promoter equipment device 102 as individually selectable listings 402 shown in FIG. 4. In an embodiment, the event promoter may request additional media content associated with specific search expressions or processes. For example, the event listings application may return to step 710 in response to an event promoter selecting feature 414 shown in FIG. 4 using input device 210 shown in FIG. 2.

At step 714, the event listings application receives one or more media content selections from the event promoter through any suitable communications path, network, or both. For example, the event listings application may receive a selection of the identified previously recorded broadcast of a Burbank High School vs. Pasadena High School baseball game in response to the event promoter selecting listing 404 shown in FIG. 4 using input device 210 shown in FIG. 2. The importance of the event promoter making the video selection is evidenced by an illustrative search for a presenter name. For example, when searching for the presenter name “John Smith,” the search engine may return videos associated with the presenter John Smith in addition to media content associated with a different (i.e., incorrect) John Smith, resulting in a need for alternate selection of video content from amongst the video choices for the integrated event listing.

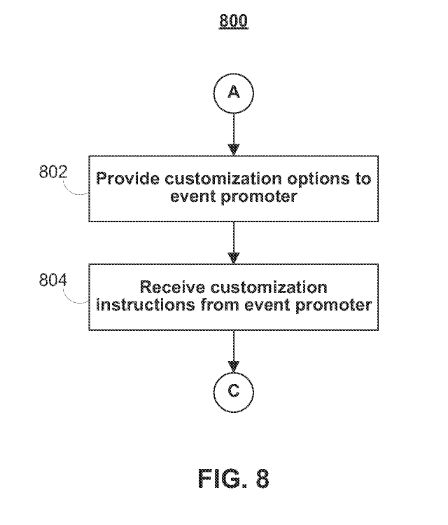

In an embodiment, the event listings application may provide additional steps to customize the display of the event information and selected media content. These additional steps may be performed at step 716 as described with respect to process 800 shown in FIG. 8. These additional steps may return to process 700 at step 718. For example, the event listings application may proceed to step 716 after step 714 in response to the event promoter selecting one or more media content listings.

At step 720, the event listings application displays the received event information and the selected media content. In an embodiment, the event listings application may associate the received event information and the selected media content with each other and display the event information and selected media content on output device 212 (FIG. 2) of user equipment 154 (FIG. 1). In certain embodiments, the event listings application may generate an integrated event listing by integrating the received event information with the selected media content using any suitable data integration or data fusion process. In an example, event listings application 110 shown in FIG. 1 may display the event information and selected media content as a foreground overlay of the received event information displayed over an online video selected by the event promoter. In another example, event listings application 110 shown in FIG. 1 may display the event information and selected media content by resizing and displaying the online video selected by the event promoter in a video display region and displaying the text of the event information in a separate display region. In another example, event listings application 110 shown in FIG. 1 display the event information and selected media content as a scrolling text overlay of the received event information displayed over an image or color background selected by the event promoter. In another example, event listings application 110 shown in FIG. 1 display the event information and selected media content as a display region of the received event information displayed during the playing of audio selected by the event promoter.

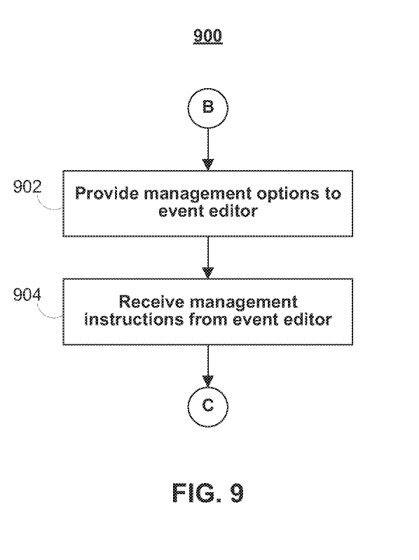

In an embodiment, the event listings application may provide additional steps to manage the display of the event information and selected media content. These additional steps may be performed at step 722 as described with respect to process 900 shown in FIG. 9. These additional steps may return to process 700 at step 718. For example, the event listings application may proceed to step 722 after step 720 in response to the event editor accessing the event information and selected media content via event listings application 110 and event editor equipment device 104 shown in FIG. 1.

Process 700 may include one or more additional steps after step 720 for distribution of the event information and selected media content. In an embodiment, the integrated event listings application may generate the integrated event listing remotely and distribute the integrated event listing to user equipment 154 shown in FIG. 1, integrated event listings database 150 shown in FIG. 1, any other suitable component, or any suitable combination after step 720. In another embodiment, the integrated event listings application may separately provide the event information from any suitable database (e.g., database 112, 146, or 150 shown in FIG. 1) and the media content associated with the event information from any suitable media content source (e.g., media content source 122, 132, or both shown in FIG. 1) to the user equipment (e.g., user equipment 154 shown in FIG. 1). For example, the integrated event listings application may download and compile event information and media content to generate the display of the event information and the selected media content in user television equipment 158 (FIG. 1). In an embodiment, the integrated events listings application may download and compile any other suitable information, such as information indicative of positioning, speed, pauses, any other suitable attribute, or any suitable combination.

FIG. 8 is a flow chart of illustrative steps 800 involved in customizing the display of the received event information and the selected media content in accordance with some embodiments of the present disclosure.

At step 802, the event listings application provides customization options to enable the event promoter to customize the manner in which the media content is to be used with the event information. The event listings application may provide one or more customization options, such as the ability to adjust the font, color, speed, ticker scroll or title scroll, pausing the text scroll during selected parts of the video, audio on/off, video on/off, event information with audio only over a single-color or stock background, using text-to-speech to read the text as audio underscoring, selection of random or sequential backgrounds from the selected media content, any other suitable option, or any suitable combination. For example, the event listings application may provide customization options as one or more selectable options 502 shown in FIG. 5. In another example, the customization options may be provided by a video editing system (e.g., Final Cut non-linear editing software).

At step 804, the event listings application receives one or more customization instructions from the event promoter through any suitable communications path, network, or both. For example, the event listings application may receive one or more instructions to modify the event category, modify the event name, modify durations, adjust fonts, adjust colors, any other suitable customization instruction, or any suitable combination in response to the event promoter selecting, for example, one or more of selectable options 502 shown in FIG. 5 or any other suitable customization option using input device 210 shown in FIG. 2. Process 800 then proceeds to step 718 shown in FIG. 7 and ends.

FIG. 9 is a flow chart of illustrative steps 800 involved in managing event listings in accordance with some embodiments of the present disclosure.

At step 902, the event listings application provides management options for the event editor to manage the display of the event information and the selected media content. The event listings application may provide one or more management options, such as the ability to adjust the font, color, speed, ticker scroll or title scroll, pausing the text scroll during selected parts of the video, audio on/off, video on/off, event information with audio only over a single-color or stock background, using text-to-speech to read the text as audio underscoring, selection of random or sequential backgrounds from the selected media content, removal of inappropriate content, formatting to broadcast or VOD standards, any other suitable option, or any suitable combination. For example, the event listings application may provide management options as one or more selectable options 502 shown in FIG. 5. In another example, the management options may be provided by a video editing system (e.g., Final Cut non-linear editing software).

In an embodiment, the event listings application may provide management options to design or manipulate the display menus of the integrated event listings application based on the preferences, requirements, or capabilities of user equipment 154 shown in FIG. 1. For example, the event listings application may provide management options for the event editor to manipulate the integrated event listings application display menus based on the type of user equipment device (e.g., user equipment device 158, 160, 162, 164 shown in FIG. 1, any other suitable device, or any suitable combination). In an embodiment, the event listings application may provide management options for the event editor to manipulate the placement, order, or both of event listings. For example, the event listings application may provide options for special placement of event listings based on arrangements made with event promoters, such as advertising opportunities or any other suitable consideration. In an embodiment, the event listings application may provide management options for the event editor to manipulate the display order of sequentially displayed event listings based on the amount of advertising revenue provided by the event promoter. For example, the event listings application may provide management options to display one event listing before another event listing in response to the event promoter of the first event listing providing a higher amount of advertising revenue than the event promoter of the second event listing.

At step 904, the event listings application receives one or more management instructions from the event editor through any suitable communications path, network, or both. For example, the event listings application may receive one or more instructions to modify the event category, modify the event name, modify durations, adjust fonts, adjust colors, remove inappropriate content, any other suitable management instruction, or any suitable combination in response to the event promoter selecting, for example, one or more of selectable options 502 shown in FIG. 5 or any other suitable management option using input device 210 shown in FIG. 2. Process 900 then proceeds to step 718 shown in FIG. 7 and ends.

It will be understood that the foregoing is merely illustrative of the principles of the disclosure, and that the disclosure may be practiced by other than the described embodiments, which are presented for purposes of illustration and not of limitation.

1. A method for providing event listings with video, the method comprising:
receiving event information indicative of an event in response to input from a user;
searching at least one media content source to identify media content related to the received event information;
providing a selectable display of the identified media content;
receiving a selection of one of the identified media content in response to input from the user; and
displaying the received event information and the selected media content.

2. The method of claim 1, wherein the event information comprises one or more of an event name, an event description, an event location, an event schedule, a presenter name, presenter contact information, a promoter name, promoter contact information, ticket information, a venue name, a venue address, and a combination thereof.

3. The method of claim 1, wherein the searching to identify media content comprises searching, using a search engine, to identify one or more of videos, images, audio, and a combination thereof.

4. The method of claim 1, further comprising transmitting the received event information and the selected media content to a distribution facility using a communications network.

5. The method of claim 4, wherein the displaying the received event information and the selected media content comprises displaying the received event information and the selected media content on user viewing equipment.

6. The method of claim 1, wherein the displaying the received event information and the selected media content comprises displaying the event information as a scrolling text overlay displayed over the selected media content.

7. The method of claim 1, further comprising integrating the received event information and the selected media content.

8. The method of claim 1, further comprising:
receiving an instruction to customize the display of the received event information and the selected media content in response to input from the user; and
customizing the display of the received event information and the selected media content based on the received instruction.

9. The method of claim 8, wherein the instruction to customize the display of the received event information and the selected media content comprises an instruction to customize one or more of speed, color, font, audio, video, scroll type, and a combination thereof.

10. The method of claim 1, wherein the selected media content is a first selected media content, further comprising:
receiving a selection of a second identified media content in response to input from the user; and
displaying the received event information, the first selected media content, and the second selected media content.

11. Computer-readable medium for use in providing event listings with video, the computer-readable medium having computer program instructions recorded thereon for:
receiving event information indicative of an event in response to input from a user;
searching at least one media content source to identify media content related to the received event information;
providing a selectable display of the identified media content;
receiving a selection of one of the identified media content in response to input from the user; and
displaying the received event information and the selected media content.

12. The computer-readable medium of claim 11, wherein the event information comprises one or more of an event name, an event description, an event location, an event schedule, a presenter name, presenter contact information, a promoter name, promoter contact information, ticket information, a venue name, a venue address, and a combination thereof.

13. The computer-readable medium of claim 11, wherein the searching to identify media content comprises searching, using a search engine, to identify one or more of videos, images, audio, and a combination thereof.

14. The computer-readable medium of claim 11, further comprising transmitting the received event information and the selected media content to a distribution facility using a communications network.

15. The computer-readable medium of claim 14, wherein the displaying the received event information and the selected media content comprises displaying the received event information and the selected media content on user viewing equipment.

16. The computer-readable medium of claim 11, wherein the displaying the received event information and the selected media content comprises displaying the event information as a scrolling text overlay displayed over the selected media content.

17. The computer-readable medium of claim 11, further comprising integrating the received event information and the selected media content.

18. The computer-readable medium of claim 11, further comprising:
receiving an instruction to customize the display of the received event information and the selected media content in response to input from the user; and
customizing the display of the received event information and the selected media content based on the received instruction.

19. The computer-readable medium of claim 18, wherein the instruction to customize the display of the received event information and the selected media content comprises an instruction to customize one or more of speed, color, font, audio, video, scroll type, and a combination thereof.

20. The computer-readable medium of claim 11, wherein the selected media content is a first selected media content, further comprising:
receiving a selection of a second identified media content in response to input from the user; and
displaying the received event information, the first selected media content, and the second selected media content.

21-30. (canceled)
